(19) United States
(12) Patent Application Publication
(10) Pub. No.: US 2025/0202034 A1
(43) Pub. Date: Jun. 19, 2025

(54) ELECTROCHEMICAL APPARATUS AND ELECTRICAL DEVICE

(71) Applicant: Ningde Amperex Technology Limited, Ningde (CN)

(72) Inventors: Mingyue HUANG, Ningde (CN); Yang LI, Ningde (CN); Wei ZHAO, Ningde (CN)

(73) Assignee: Ningde Amperex Technology Limited, Ningde (CN)

(21) Appl. No.: 19/066,298

(22) Filed: Feb. 28, 2025

Related U.S. Application Data
(63) Continuation of application No. PCT/CN2023/110806, filed on Aug. 2, 2023.

(30) Foreign Application Priority Data
Aug. 31, 2022 (CN) 202211054875.0

(51) Int. Cl. H01M 50/342; H01M 50/109

(52) U.S. Cl. CPC H01M 50/3425; H01M 50/109

(57) ABSTRACT

An electrochemical apparatus includes a housing and a sealing nail. A wall of the housing is provided with a through hole that runs through the wall of the housing. The sealing nail is disposed on the housing, the sealing nail masks and seals the through hole, the sealing nail includes a weak area and a non-weak area, a thickness of the weak area is less than the thickness of the non-weak area of the sealing nail, the weak area includes a starting end and a tail end, and the starting end and the tail end are separated. A thickness of the housing is H1, and the thickness of the sealing nail is H2, where 0.1≤H2/H1≤0.7

### CROSS-REFERENCE TO RELATED APPLICATIONS

This application is a continuation application of International Application No. PCT/CN2023/110806, filed on Aug. 2, 2023, which claims the benefit of priority of Chinese patent application 202211054875.0, filed on Aug. 31, 2022, the contents of which are incorporated herein by reference in its entirety.

### TECHNICAL FIELD

This application relates to the technical field of energy storage, and in particular, to an electrochemical apparatus and an electrical device.

### BACKGROUND

Currently, to improve safety performance of a hard-housing battery, a housing is usually processed to form a weak area. When air pressure in the battery is high, gas in the battery can break through the weak area, so that the battery can exhaust the gas and relieve the pressure. Because the housing of the hard-housing battery is thick, during processing of the weak area, a removal amount of the weak area is large, causing high processing costs. In addition, the housing of the hard-housing battery is mostly a stamping, and a thickness of the stamping fluctuates greatly, causing poor precision of a remaining thickness in the weak area, which affects a pressure relief effect.

### SUMMARY

In view of the foregoing situation, it is necessary to provide an electrochemical apparatus to reduce a removal amount of a weak area.

An embodiment of this application provides an electrochemical apparatus, including a housing and a sealing nail. A wall of the housing is provided with a through hole that runs through the wall of the housing. The sealing nail is disposed on the housing, the sealing nail masks and seals the through hole, the sealing nail includes a weak area and a non-weak area, a thickness of the weak area is less than the thickness of the non-weak area of the sealing nail, the weak area includes a starting end and a tail end, and the starting end and the tail end are separated. A thickness of the housing is H1, and the thickness of the sealing nail is H2, where 0.1≤H2/H1≤0.7.

In the foregoing electrochemical apparatus, the thickness of the sealing nail is less than the thickness of the housing, the non-closed-loop weak area is provided on the sealing nail, the thickness of the weak area is less than the thickness of the sealing nail, and a ratio of the thickness of the sealing nail to the thickness of the housing is between 0.1 and 0.7, which not only enables the weak area of the electrochemical apparatus to be broken through to exhaust gas and relieve pressure when the internal air pressure increases, but also can reduce a removal amount in processing of the weak area and save processing costs when a same pressure relief requirement is met.

In some embodiments of this application, ⅓≤H2/H1≤½.

The foregoing ratio of the thickness of the sealing nail to the thickness of the housing is between ⅓ and ½, which can reduce the removal amount in processing of the weak area and save processing costs on the premise of ensuring structural strength of the sealing nail so as to ensure the sealing effect.

In some embodiments of this application, the housing includes a top wall, a side wall, and a bottom wall, the side wall connects the top wall and the bottom wall, and the through hole is provided on the top wall, the side wall, or the bottom wall.

In some embodiments of this application, the thickness of the weak area is H3, and 0.2≤H3/H2≤0.9.

The foregoing ratio of the thickness of the weak area to the thickness of the sealing nail is between 0.2 and 0.9, which can enable the weak area to break through earlier than the sealing nail to relieve pressure when the air pressure in the electrochemical apparatus increases, and can also reducing processing difficulty of the weak area and improve processing quality of the weak area.

In some embodiments of this application, 0.2≤H3/H2≤0.5.

A foregoing ratio of the thickness of the weak area to the thickness of the sealing nail is between 0.2 and 0.5, which can reduce a pressure relief threshold of the electrochemical apparatus and further improve safety performance of the electrochemical apparatus.

In some embodiments of this application, a circumference of the sealing nail is L1, a length of the weak area is L2, 0.25≤L2/L1≤1.4, and the length L2 of the weak area is a total length from the starting end to the tail end of the weak area.

A foregoing ratio of the length of the weak area to the circumference of the sealing nail is between 0.25 and 1.4, which enables the weak area to be broken through earlier than the sealing nail when internal air pressure of the electrochemical apparatus increases, so as to exhaust gas and relieve the pressure.

In some embodiments of this application, 0.35≤L2/L1≤0.8.

A foregoing ratio of the length of the weak area to the circumference of the sealing nail is between 0.35 and 0.8, which can improve precision for pressure relief strength in the electrochemical apparatus and improve safety control of air pressure in the electrochemical apparatus.

In some embodiments of this application, the sealing nail is provided with a first recess, the first recess is formed by a surface depression of the sealing nail, a bottom wall of the first recess constitutes a partial surface of the weak area, and a projection of the first recess overlaps a projection of the weak area in a thickness direction of the sealing nail.

The foregoing first recess constitutes the weak area on the sealing nail, and when air pressure in the electrochemical apparatus increases, internal gas can break through the weak area to exhaust the gas and relieve the pressure of the electrochemical apparatus and improve safety of the electrochemical apparatus.

In some embodiments of this application, a width of an opening of the first recess is W1, a width of the bottom wall of the first recess is W2, and W1/W2≥1.1.

In some embodiments of this application, the housing is provided with a second recess, the second recess is formed by a surface depression of the housing, the through hole runs through the second recess, and at least a part of the sealing nail is accommodated in the second recess and connected to a bottom wall of the second recess.

The foregoing sealing nail is partially accommodated in the second recess and connected to the bottom wall of the second recess, which can reduce influence of a volume of the sealing nail on a volume of the electrochemical apparatus and reduce influence of the sealing nail on energy density of the electrochemical apparatus.

In some embodiments of this application, the sealing nail is fixedly connected to the bottom wall of the second recess, a part of the sealing nail in contact with the bottom wall of the second recess forms a closed-loop connection area, and a projection of the connection area surrounds a projection of the weak area in a thickness direction of the sealing nail.

The foregoing sealing nail is fixedly connected to the bottom wall of the second recess, and the projection of the connection area of the sealing nail and the second recess surrounds the projection of the weak area, so that gas in the electrochemical apparatus can act on the weak area, and there is a possibility of breaking through the weak area.

In some embodiments of this application, a depth of the second recess is H4, and H4≥H2.

The foregoing depth of the second recess is not less than the thickness of the sealing nail, and when the sealing nail is connected to the bottom wall of the second recess, the entire sealing nail is located in the second recess and does not protrude from the second recess, which can reduce influence of the thickness of the sealing nail on a volume or an outline volume of the electrochemical apparatus and improve energy density of the electrochemical apparatus.

In some embodiments of this application, 10 μm≤H2≤60 μm, and 50 μm≤H1≤300 μm.

The foregoing thickness ranges of the side wall and the sealing nail can reduce a removal amount in processing of the weak area and improve precision of a remaining thickness of the weak area after processing on the premise of ensuring structural strength of the side wall and the sealing nail.

In some embodiments of this application, 60 μm≤W1≤200 μm, and W2≥0.

The foregoing size ranges of the width of the opening of the first recess and the width of the bottom wall of the first recess can help form the weak area, reduce a removal amount in processing of the first recess, and save costs.

An embodiment of this application also provides an electrical device, including the electrochemical apparatus described in any of the foregoing embodiments.

In the foregoing electrical device, a weak area of the electrochemical apparatus can be broken through to exhaust gas and relieve pressure when the internal air pressure increases, and a removal amount in processing of the weak area can also be reduced. When safety of the electrochemical apparatus is improved, costs of the electrochemical apparatus can be saved, influence of the electrochemical apparatus on the electrical device caused by the excessively large internal air pressure can be reduced, and costs of the electrical device are saved.

### BRIEF DESCRIPTION OF DRAWINGS

FIG. 1 is a first view of an electrochemical apparatus according to an embodiment of this application;

FIG. 2 is an exploded view of an electrochemical apparatus according to an embodiment of this application;

FIG. 3 is a second view of an electrochemical apparatus according to an embodiment of this application;

FIG. 4 is a schematic diagram of a partial structure of an IV-IV section in FIG. 3;

FIG. 5 is a schematic structural diagram of a sealing nail according to an embodiment of this application;

FIG. 6 is a schematic structural diagram of an extended embodiment of the sealing nail shown in FIG. 5;

FIG. 7 is a schematic structural diagram of an extended embodiment of the sealing nail shown in FIG. 5;

FIG. 8 is a schematic structural diagram of a sealing nail in Comparative embodiment 4; and

FIG. 9 is a schematic structural diagram of an electrical device according to an embodiment of this application.

Reference numeral description of main components

| | |
|---|---|
| Electrochemical apparatus | 100 |
| Housing | 10 |
| Top wall | 11 |
| Through hole | 111 |
| Second recess | 112 |
| Connection area | 113 |
| Cavity | 12 |
| Side wall | 121 |
| Bottom wall | 122 |
| Cavity space | 13 |
| Sealing nail | 20 |
| Weak area | 21 |
| Starting end | 211 |
| Tail end | 212 |
| First recess | 22 |
| Bottom plate | 23 |
| Electrode assembly | 30 |
| Electrical device | 200 |

This application is further described by using the following specific implementations with reference to the foregoing accompanying drawings.

### DETAILED DESCRIPTION

The technical solutions in the embodiments of this application are described with reference to the accompanying drawings in the embodiments of this application. Apparently, the described embodiments are merely some rather than all of the embodiments of this application.

It should be noted that when one element is referred to as being “connected” to another element, it may be directly connected to the another element or there may also be an element provided therebetween. When one element is referred to as being “disposed” on another element, it may be directly disposed on the another element or there may also be an element provided therebetween.

Unless otherwise defined, all technical and scientific terms used herein have the same meanings as commonly understood by a person skilled in the technical field to which this application belongs. The terms used in the description of this application are merely intended to describe specific embodiments but not to limit this application.

An embodiment of this application provides an electrochemical apparatus, including a housing and a sealing nail. A wall of the housing is provided with a through hole that runs through the wall of the housing. The sealing nail is disposed on the housing, the sealing nail masks and seals the through hole, the sealing nail includes a weak area and a non-weak area, a thickness of the weak area is less than the thickness of the non-weak area of the sealing nail, the weak area includes a starting end and a tail end, and the starting end and the tail end are separated. A thickness of the housing is H1, and the thickness of the sealing nail is H2, where 0.1≤H2/H1≤0.7.

In the foregoing electrochemical apparatus, the thickness of the sealing nail is less than the thickness of the housing, the non-closed-loop weak area is provided on the sealing nail, the thickness of the weak area is less than the thickness of the sealing nail, and a ratio of the thickness of the sealing nail to the thickness of the housing is between 0.1 and 0.7, which not only enables the weak area of the electrochemical apparatus to be broken through to exhaust gas and relieve pressure when the internal air pressure increases, but also can reduce a removal amount in processing of the weak area and save processing costs when a same pressure relief requirement is met.

Embodiments of this application are further illustrated below with reference to the accompanying drawings.

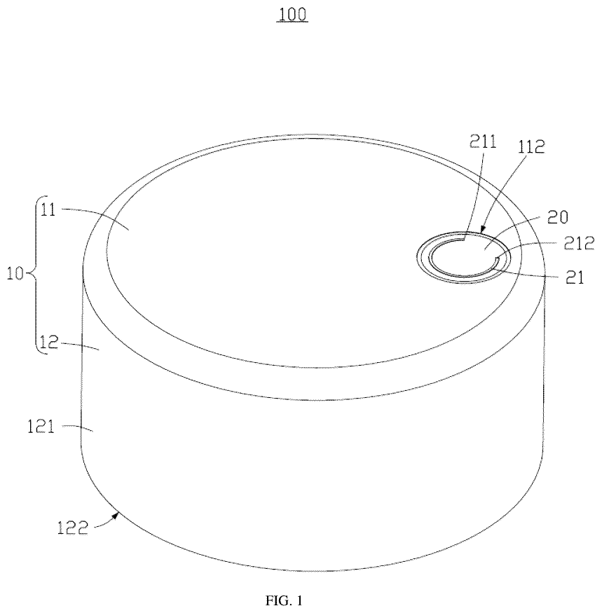

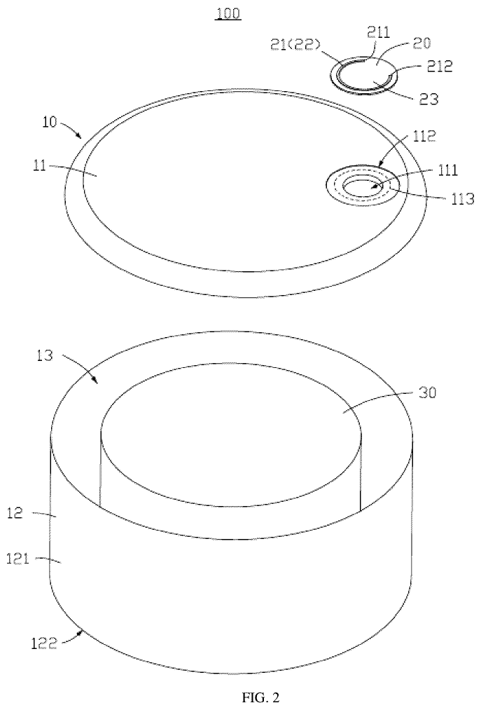

As shown in FIG. 1 and FIG. 2, an implementation of this application provides an electrochemical apparatus 100 including a housing 10, a sealing nail 20, and an electrode assembly 30. The sealing nail 20 is disposed on the housing 10, and the electrode assembly 30 is disposed inside the housing 10. The housing 10 is provided with a through hole 111 that runs through the housing 10. The sealing nail 20 is disposed on the housing 10, the sealing nail 20 masks and seals the through hole 111, the sealing nail 20 includes a weak area 21, a thickness of the weak area 21 is less than a thickness of the sealing nail 20, the weak area 21 includes a starting end 211 and a tail end 212, and the starting end 211 and the tail end 212 are separated. A thickness of the housing 10 is H1, and the thickness of the sealing nail 20 is H2, where 0.1≤H2/H1≤0.7.

In the foregoing electrochemical apparatus 100, the sealing nail 20 is disposed on the housing 10. The thickness of the sealing nail 20 is less than the thickness of the housing 10, the weak area 21 is provided on the sealing nail 20, the thickness of the weak area 21 is less than the thickness of the sealing nail 20, and a ratio of the thickness of the sealing nail 20 to the thickness of the housing 10 is between 0.1 and 0.7. This not only enables the weak area 21 of the electrochemical apparatus 100 to be broken through to exhaust gas and relieve pressure when the internal air pressure increases, but also can reduce a removal amount in processing of the weak area 21 and save processing costs when a same pressure relief requirement is met. Further, the starting end 211 of the weak area 21 and the tail end 212 are separated, so that a part enclosed by the weak area 21 is of a non-closed-loop structure. When the gas in the electrochemical apparatus 100 breaks through the weak area 21, a broken part of the weak area 21 forms an opening structure, but a part between the starting end 211 and the end 212 can be used as a connection structure to avoid a case in which the part enclosed by the weak area 21 is detached from the sealing nail 20, thereby reducing influence on external environment caused because a partial structure of the sealing nail 20 is rushed by the internal gas, for example, impact injury.

In an embodiment, ⅓≤H2/H1≤½, which can reduce a removal amount in processing of the weak area 21 and save processing costs on the premise of ensuring structural strength of the sealing nail 20 so as to ensure a sealing effect. In addition, because the thickness of the sealing nail 20 is less than that of the housing 10, and the thickness of the sealing nail 20 is more even, precision of a remaining thickness of the sealing nail 20 after the weak area 21 is processed is also high, thereby helping improve a pressure relief effect. Optionally, H2/H1=0.4.

In an embodiment, a material of the housing 10 is steel, which can reduce the thickness of the housing 10 on the premise of ensuring structural strength of the housing 10, and reduce influence of the thickness of the housing 10 on energy density of the electrochemical apparatus 100. In an embodiment, 50 μm≤H1≤300 μm. A thickness range of the housing 10 can ensure that the structural strength of the housing 10 meets a design requirement of the electrochemical apparatus 100, and can also reduce the influence of the thickness of the housing 10 on the energy density of the electrochemical apparatus 100. In an embodiment, 100 μm≤H1≤200 μm. Optionally, H1=150 μm.

In an embodiment, a material of the sealing nail 20 is steel, which can reduce the thickness of the sealing nail 20 on the premise of ensuring the structural strength of the sealing nail 20, thereby reducing a removal amount in processing of the weak area 21, and saving costs. In addition, the thickness of the sealing nail 20 is small, which can improve thickness precision of the sealing nail 20, thereby improving precision of the remaining thickness of the weak area 21, and improving pressure relief precision of the electrochemical apparatus 100. In an embodiment, 10 μm≤H2≤60 μm. A thickness range of the sealing nail 20 can ensure that the structural strength of the sealing nail 20 meets a design requirement of the electrochemical apparatus 100, and can also reduce the removal amount of the weak area 21, and save costs. In an embodiment, 20 μm≤H2≤40 μm. Optionally, H2=30 μm.

The housing 10 includes a top wall 11 and a cavity 12, the cavity 12 has an opening, and the top wall 11 can be connected to the cavity 12 and steal the opening of the cavity 12, thereby forming a cavity space 13 that can accommodate the electrode assembly 30. In an embodiment, the top wall 11 and the cavity 12 are connected through welding. In an embodiment, a material of the cavity 12 is steel, which can reduce a thickness of the cavity 12 on the premise of ensuring structural strength of the cavity 12, and reduce influence of the thickness of the cavity 12 on the energy density of the electrochemical apparatus 100.

The cavity 12 includes a side wall 121 and a bottom wall 122, the side wall 121 connects the top wall 11 and the bottom wall 122, and the top wall 11, the side wall 121, and the bottom wall 122 are enclosed to form the cavity space 13. In an embodiment, the side wall 121 and the bottom wall 122 are connected through welding. In an embodiment, the side wall 121 and the bottom wall 122 are of a one-piece structure that is formed through stamping. In an embodiment, the top wall 11 and the bottom wall 122 are of a one-piece structure that is formed through stamping, and the side wall 121 and the bottom wall 122 are connected through welding.

In an embodiment, the through hole 111 runs through the top wall 11, and the sealing nail 20 is disposed on the top wall 11. In an embodiment, the through hole 111 runs through the bottom wall 122, and the sealing nail 20 is disposed on the bottom wall 122 (not shown in the figures). Exemplarily, the following provides further descriptions by using an example in which the through hole 111 runs through the top wall 11 and the sealing nail 20 is disposed on the top wall 11.

In this application, a thickness of the top wall 11 is H1. Optionally, a thickness of the side wall 121 and a thickness of the bottom wall 122 are also H1.

In an embodiment, the sealing nail 20 includes a bottom plate 23, the bottom plate 23 is connected to the top wall 11, the weak area 21 is provided on the bottom plate 23, and the thickness H2 of the sealing nail 20 is a thickness of the bottom plate 23. In other embodiments, the sealing nail 20 further includes other structures (not shown in the figures), for example, rubber protrusions, disposed on the bottom plate 23.

In an embodiment, the electrode assembly 30 includes a first electrode plate, a second electrode plate, and a separator (not shown in the figures), the separator is disposed between the first electrode plate and the second electrode plate, and the first electrode plate, the separator, and the second electrode plate are stacked or wound to form the electrode assembly 30. Optionally, the first electrode plate, the separator, and the second electrode plate are sequentially stacked.

In an embodiment, one of the first electrode plate and the second electrode plate is a positive electrode plate, and the other of the first electrode plate and the second electrode plate is a negative electrode plate.

Exemplarily, the following provides further descriptions by using an example in which the first electrode plate, the separator, and the second electrode plate are sequentially stacked.

In an embodiment, the electrode assembly 30 includes a plurality of first electrode plates, separators, and second electrode plates, and the separator is disposed between the first electrode plate and the second electrode plate that are adjacent.

In an embodiment, the electrochemical apparatus 100 further includes a terminal (not shown in the figures), the terminal is disposed on the top wall 11, and a part of the terminal is exposed on the top wall 11. At least one of the plurality of first electrode plates is electrically connected to the cavity 12, at least one of the plurality of second electrode plates is electrically connected to the terminal, and the cavity 12 and the terminal respectively serve as a positive electrode and a negative electrode of the electrochemical apparatus 100. In an embodiment, the electrochemical apparatus 100 is a button battery.

In an embodiment, the electrochemical apparatus 100 further includes an insulating member (not shown in the figures). A part of the terminal is located inside the housing 10, and the insulating member connects the terminal and the top wall 11, so that the terminal and the top wall 11 are insulated from each other, thereby reducing a risk of a short circuit in the electrochemical apparatus 100 caused by the terminal electrically connected to the top wall 11.

In an embodiment, all of the first electrode plates are electrically connected to the cavity 12 and all of the second electrode plates are electrically connected to the terminal.

In an embodiment, the top wall 11 is provided with a second recess 112, the second recess 112 is formed by a surface depression of the top wall 11, the through hole 111 runs through the second recess 112, at least a part of the sealing nail 20 is located in the second recess 112, and the sealing nail 20 is connected to a bottom wall of the second recess 112. The sealing nail 20 is partially accommodated in the second recess 112 and connected to the bottom wall of the second recess 112, which can reduce influence of a volume of the sealing nail 20 on a volume of the electrochemical apparatus 100 and reduce influence of the sealing nail 20 on the energy density of the electrochemical apparatus 100. In an embodiment, the bottom plate 23 is located in the second recess 112.

In an embodiment, the second recess 112 is disposed on a side of the top wall 11 facing away from the cavity space 13, and the sealing nail 20 is located outside the cavity space 13. In other embodiments, the second recess 112 is provided on a side (not shown in the figures) of the top wall 11 close to the cavity space 13, and a part of the sealing nail 20 is located inside the cavity space 13.

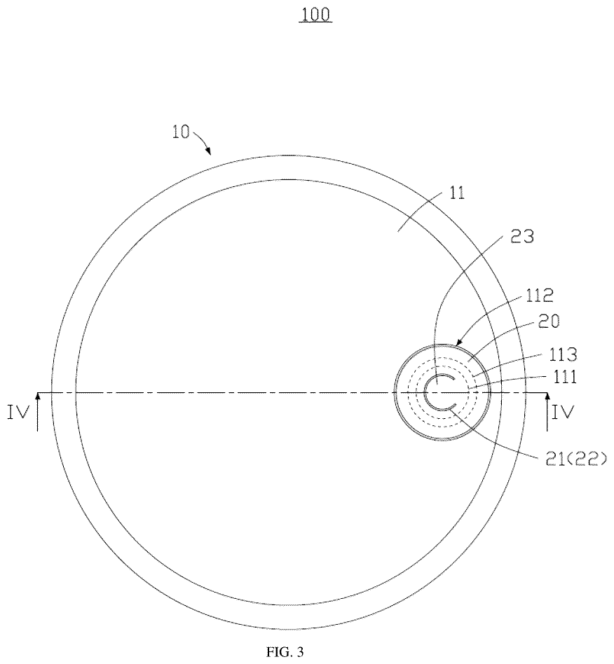

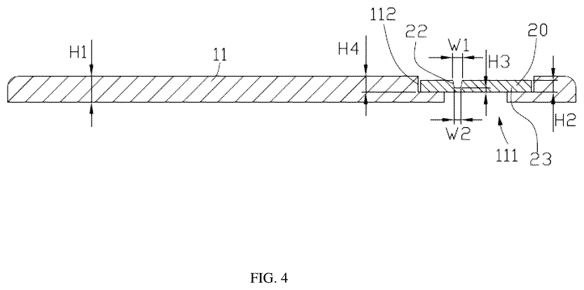

As shown in FIG. 2, FIG. 3, and FIG. 4, in an embodiment, the bottom plate 23 is fixedly connected to the bottom wall of the second recess 112, and a part of the bottom plate 23 in contact with the bottom wall of the second recess 112 forms a closed-loop connection area 113. A projection of the connection area 113 surrounds a projection of the weak area 21 in a thickness direction of the bottom plate 23, so that the gas in the electrochemical apparatus 100 can act on the weak area 21, and there is a possibility that the gas breaks through the weak area 21. In an embodiment, the projection of the weak area 21 is located within a projection of the through hole 111 in the thickness direction of the bottom plate 23.

In an embodiment, the bottom plate 23 is fixedly connected to the bottom wall of the second recess 112 through welding, and a welded area between the bottom plate 23 and the bottom wall of the second recess 112 constitutes a connection area 113. The connection area 113 can not only function as a fixed connection, but also perform a sealing function, thereby reducing a risk of substance in the housing 10 flowing out through a gap between the bottom plate 23 and the second recess 112.

In an embodiment, a depth of the second recess 112 is H4, where H4≥H2. When the bottom plate 23 is connected to the bottom wall of the second recess 112, the bottom plate 23 is all located in the second recess 112 and does not protrude from the second recess 112, which can reduce influence of the thickness of the bottom plate 23 on a volume or an outline volume of the electrochemical apparatus 100, and increase the energy density of the electrochemical apparatus 100. Optionally, H4>H2.

In an embodiment, a circumference of the bottom plate 23 is L1, and a length of the weak area 21 is L2, where 0.25≤L2/L1≤1.4, which enables the weak area 21 to be broken through earlier than other parts of the bottom plate 23 when air pressure inside the electrochemical apparatus 100 increases, so that gas exhaustion and pressure relief are achieved. The length L2 of the weak area 21 is a total length from the starting end 211 to the tail end 212 of the weak area 21.

In an embodiment, 0.35≤L2/L1≤0.8, which can improve precision for pressure relief strength in the electrochemical apparatus 100 and improve safety control of air pressure in the electrochemical apparatus 100. Optionally, L2/L1=0.5.

In an embodiment, a thickness of the weak area 21 is H3, where 0.2≤H3/H2≤0.9, which can enable the weak area 21 to break earlier than the other parts of the bottom plate 23 to relieve the pressure when the air pressure in the electrochemical apparatus 100 increases, and can also increase processing difficulty of reducing the weak area 21, and improve processing quality of the weak area 21.

In an embodiment, 0.2≤H3/H2≤0.5, which can reduce a pressure relief threshold of the electrochemical apparatus 100, and further improve safety performance of the electrochemical apparatus 100. Optionally, a value of H3/H2 is any one of 0.2, 0.3, 0.4, and 0.5.

In an embodiment, the bottom plate 23 is provided with a first recess 22, the first recess 22 is formed by a surface depression of the bottom plate 23, a bottom wall of the first recess 22 constitutes a partial surface of the weak area 21, and a projection of the first recess 22 overlaps the projection of the weak area 21 in the thickness direction of the bottom plate 23. The first recess 22 thins a partial area of the bottom plate 23, so as to form the weak area 21. When the air pressure in the electrochemical apparatus 100 increases, the internal gas can break through the weak area 21 to exhaust the gas and relieve the pressure of the electrochemical apparatus 100, and improve safety of the electrochemical apparatus 100.

In an embodiment, a width of an opening of the first recess 22 is W1, and a width of the bottom wall of the first recess 22 is W2, where W1/W2≥1.1. A cross section of the first recess 22 is of a concave structure in which the opening is larger than a bottom. When the internal gas of the electrochemical apparatus 100 breaks through the weak area 21, the bottom wall of the first recess 22 is cracked, and the gas flows from the bottom of the first recess 22 and flows out through the opening of the first recess 22. The structure of the first recess 22 in which the opening is larger than the bottom can reduce resistance to gas flow, reduce a risk of gas accumulation inside the first recess 22, and allow the gas to be quickly exhausted. Optionally, W1/W2=1.5. Optionally, the cross section of the first recess 22 is of a trapezoidal structure.

In an embodiment, 60 μm≤W1≤200 μm. A size range of the width of the opening of the first recess 22 can reduce a removal amount in processing of the first recess 22, and save costs. In an embodiment, 100 μm≤W1≤160 μm. Optionally, W1=120 μm.

In an embodiment, W2≥0, which enables the bottom of the first recess 22 to form the weak area 21 of the sealing nail 20, so that when the air pressure inside the electrochemical apparatus 100 increases, the weak area 21 can be broken through to exhaust the gas and relieve the pressure.

In an embodiment, the opening of the first recess 22 faces a direction facing away from the cavity space 13. In other embodiments, the opening of the first recess 22 faces the cavity space 13 and communicates with the cavity space 13 (not shown in the figures).

In an embodiment, the first recess 22 is obtained through laser etching processing.

In an embodiment, the electrochemical apparatus 100 injects electrolyte into the housing 10 through the through hole 111, and the sealing nail 20 is connected to the bottom wall of the second recess for sealing the through hole 111.

In an embodiment, the bottom plate 23 is of a plate structure, and the thickness of the bottom plate 23 is relatively even. The cavity 12 is of a stamping structure, and the thickness of the cavity 12 has a relatively large error. Compared with provision of the weak area 21 on the cavity 12, provision of the weak area 21 on the bottom plate 23 can improve dimensional precision of the remaining thickness of the weak area 21 after processing, thereby improving the pressure relief effect of the electrochemical apparatus 100.

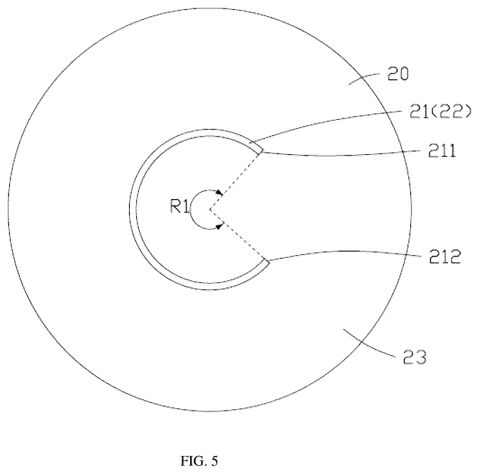

As shown in FIG. 5, in an embodiment, a shape of a trajectory of the weak area 21 is approximately circular when viewed in the thickness direction of the bottom plate 23, and a central angle of the weak area 21 between the starting end 211 and the tail end 212 is R1, where R1>180°. Optionally, R1=270°.

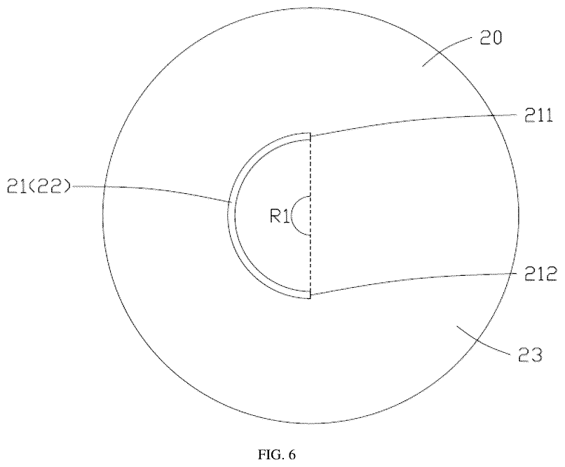

As shown in FIG. 6, in an embodiment, R1=180°.

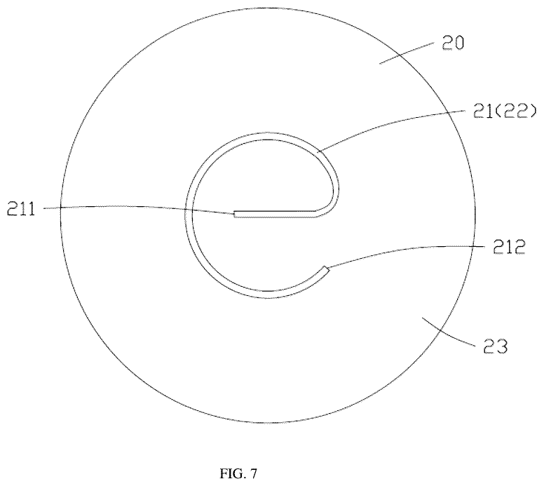

As shown in FIG. 7, in an embodiment, when viewed in the thickness direction of the bottom plate 23, the shape of the trajectory of the weak area 21 is approximately e-shaped, which can extend the length of the weak area 21, and thus reduce an air pressure threshold for pressure relief based on the weak area 21 in the electrochemical apparatus 100.

To verify the pressure relief effect of the electrochemical apparatus 100 in this application, tests are carried out and specific information is as follows.

### Embodiment 1

The electrochemical apparatus 100 described in any embodiment of this application is used. Materials of the top wall 11, the cavity 12, and the sealing nail 20 are all 316L stainless steel, the thicknesses of the top wall 11 and the cavity 12 are both 150 μm, the thickness of the bottom plate 23 is 45 μm, a circumference of the sealing nail 20 is 2.1*π mm, a circumference of the connection area 113 is 1.6*π mm, the width of the opening of the first recess 22 is 110 μm, a depth of the first recess 22 is 24±6 μm, the trajectory of the weak area 21 is in the shape shown in FIG. 5, and a length of the trajectory of the weak area 21 is 1.2*π mm.

A test environment is as follows: The electrochemical apparatus 100 is placed in a hot box in a fully charged state, an internal ambient temperature of the hot box ranges from 180° C. to 200° C., and a placement time period is 30 minutes.

Ten groups of identical electrochemical apparatuses 100 are placed in the foregoing test environment, and when the test is completed, states of the ten groups of electrochemical apparatuses 100, broken states of weak areas 21, and a quantity of broken weak areas 21 are recorded. Because a large amount of gas and a large amount of heat are generated inside the electrochemical apparatus 100 in a high-temperature (180° C. to 200° C.) environment, if the electrochemical apparatus 100 does not explode and cracking occurs in the weak area 21, it indicates that the electrochemical apparatus 100 can complete gas exhaust and pressure relief, and a test result is qualified; if the electrochemical apparatus 100 explodes or the weak area 21 is intact, it indicates that the electrochemical apparatus 100 cannot complete gas exhaust and pressure relief in the weak area 21, and a test result is unqualified.

### Embodiment 2

An only difference in testing conditions and an environment from these in Embodiment 1 lies in a shape and length of the weak area 21. A trajectory of the weak area 21 in Embodiment 2 is the shape shown in FIG. 6, and the length is π/2 mm.

### Embodiment 3

An only difference in testing conditions and an environment from these in Embodiment 1 lies in a shape and length of the weak area 21. A trajectory of the weak area 21 in Embodiment 3 is the shape shown in FIG. 7, and the length is (1.2*π+1.2) mm.

Quantities of broken weak areas 21 in each ten groups of electrochemical apparatuses 100 in the test experiments of Embodiment 1, Embodiment 2, and Embodiment 3 are recorded.

### Comparative Embodiment

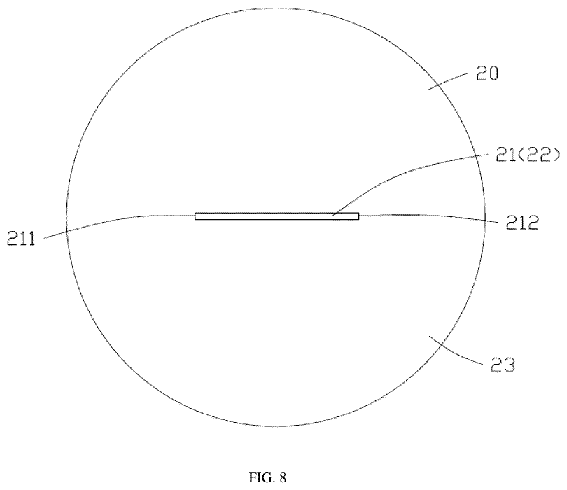

An only difference in testing conditions and an environment from these in Embodiment 1 lies in a shape and length of the weak area 21. A trajectory of the weak area 21 in the comparative embodiment is a straight line shown in FIG. 8, and the length is 1.2 mm.

A quantity of broken weak areas 21 in ten groups of electrochemical apparatuses 100 in the comparative embodiment is recorded.

The foregoing four groups of data are compared as shown in the table below.

| | Quantity of qualified |
|---|---|
| | tests |
| Embodiment 1 | 10/10 |
| Embodiment 2 | 10/10 |
| Embodiment 3 | 10/10 |
| Comparative | 1/10 |
| embodiment | |

With reference to the foregoing table, it can be learned that all electrochemical apparatuses 100 in the three embodiments can successfully implement gas exhaust and pressure relief based on the weak area 21, while the electrochemical apparatus 100 in the comparative embodiment does not use embodiments of this application, and the electrochemical apparatus 100 in the comparative embodiment almost cannot implement gas exhaust and pressure relief based on the weak area 21.

In conclusion, in the foregoing electrochemical apparatus 100 in this application, the sealing nail 20 is disposed on the housing 10. The thickness of the sealing nail 20 is less than the thickness of the housing 10, the non-closed-loop weak area 21 is provided on the sealing nail 20, the thickness of the weak area 21 is less than the thickness of the sealing nail 20, and the ratio of the thickness of the sealing nail 20 to the thickness of the housing 10 is between 0.1 and 0.7, which not only enables the weak area 21 of the electrochemical apparatus 100 to be broken through to exhaust the gas and relieve the pressure when the internal air pressure increases, but also can reduce the removal amount in processing of the weak area 21 and save processing costs when the same pressure relief requirement is met.

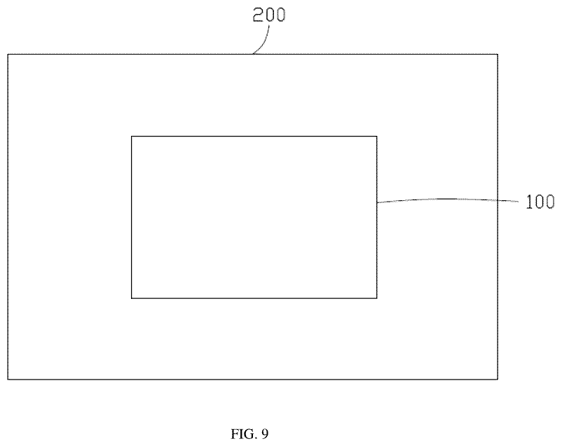

As shown in FIG. 9, an embodiment of this application further provides an electrical device 200, including the electrochemical apparatus 100 described in any of the foregoing embodiments, and the electrochemical apparatus 100 may provide electrical energy for the electrical device 200.

In an embodiment, the electrical device 200 includes electronic devices such as an unmanned aerial vehicle, a mobile phone, a watch, a tablet computer, and a notebook computer.

In the foregoing electrical device 200, the electrochemical apparatus 100 can break through the weak area 21 to exhaust gas and relieve pressure when the internal air pressure increases, and can also reduce the removal amount in processing of the weak area 21. When safety of the electrochemical apparatus 100 is improved, costs of the electrochemical apparatus 100 can be saved, influence of excessively large internal air pressure of the electrochemical apparatus 100 on the electrical device 200 can be reduced, and costs of the electrical device 200 are saved.

In addition, other changes may be made by persons skilled in the art within the spirit of this application, and certainly, these changes made in accordance with the spirit of this application shall be included in the scope disclosed in this application.

What is claimed is:

1. An electrochemical apparatus comprising:
a housing, wherein a wall of the housing is provided with a through hole that runs through the wall of the housing; and
a sealing nail disposed on the housing, the sealing nail masks and seals the through hole, the sealing nail comprises a weak area and a non-weak area, a thickness of the weak area is less than the thickness of the non-weak area of the sealing nail, the weak area comprises a starting end and a tail end, and the starting end and the tail end are separated, wherein
a thickness of the housing is H1, and the thickness of the sealing nail is H2, wherein 0.1≤H2/H1≤0.7.

2. The electrochemical apparatus according to claim 1, wherein the housing comprises a top wall, a side wall, and a bottom wall, the side wall connects the top wall and the bottom wall; and the through hole is provided on the top wall, the side wall, or the bottom wall.

3. The electrochemical apparatus according to claim 1, wherein ⅓≤H2/H1≤½.

4. The electrochemical apparatus according to claim 1, wherein the thickness of the weak area is H3, and 0.2≤H3/H2≤0.9.

5. The electrochemical apparatus according to claim 4, wherein 0.2≤H3/H2≤0.5.

6. The electrochemical apparatus according to claim 1, wherein a circumference of the sealing nail is L1, a length of the weak area is L2, 0.25≤L2/L1≤1.4, and the length L2 of the weak area is a total length from the starting end to the tail end of the weak area.

7. The electrochemical apparatus according to claim 6, wherein 0.35≤L2/L1≤0.8.

8. The electrochemical apparatus according to claim 1, wherein the sealing nail is provided with a first recess, the first recess is formed by a surface depression of the sealing nail, a bottom wall of the first recess constitutes a partial surface of the weak area, and a projection of the first recess overlaps a projection of the weak area when viewed in a thickness direction of the sealing nail.

9. The electrochemical apparatus according to claim 8, wherein a width of an opening of the first recess is W1, a width of the bottom wall of the first recess is W2, and W1/W2≥1.1.

10. The electrochemical apparatus according to claim 1, wherein the housing is provided with a second recess, the second recess is formed by a surface depression of the housing, the through hole runs through the second recess, and at least a part of the sealing nail is accommodated in the second recess and connected to a bottom wall of the second recess.

11. The electrochemical apparatus according to claim 10, wherein the sealing nail is fixedly connected to the bottom wall of the second recess, a part of the sealing nail in contact with the bottom wall of the second recess forms a closed-loop connection area, and a projection of the connection area surrounds a projection of the weak area in a thickness direction of the sealing nail.

12. The electrochemical apparatus according to claim 10, wherein a depth of the second recess is H4, and H4≥H2.

13. The electrochemical apparatus according to claim 1, wherein 10 μm≤H2≤60 μm, and 50 μm≤H1≤300 μm.

14. The electrochemical apparatus according to claim 9, wherein 60 μm≤W1≤200 μm, and W2≥0.

15. An electrical device, wherein the electrical device comprises the electrochemical apparatus according to claim 1.

16. The electrical device according to claim 15, wherein the housing comprises a top wall, a side wall, and a bottom wall, the side wall connects the top wall and the bottom wall, and the through hole is provided on the top wall, the side wall, or the bottom wall.

17. The electrical device according to claim 15, wherein the thickness of the weak area is H3, and 0.2≤H3/H2≤0.9.

18. The electrical device according to claim 15, wherein a circumference of the sealing nail is L1, a length of the weak area is L2, 0.25≤L2/L1≤1.4, and the length L2 of the weak area is a total length from the starting end to the tail end of the weak area.

19. The electrical device according to claim 15, wherein the sealing nail is provided with a first recess, the first recess is formed by a surface depression of the sealing nail, a bottom wall of the first recess constitutes a partial surface of the weak area, and a projection of the first recess overlaps a projection of the weak area when viewed in a thickness direction of the sealing nail.

20. The electrical device according to claim 15, wherein 10 μm≤H2≤60 μm, and 50 μm≤H1≤300 μm.
